(19) United States
(12) Patent Application Publication
(10) Pub. No.: US 2015/0207696 A1
(43) Pub. Date: Jul. 23, 2015

(54) Predictive Anomaly Detection of Service Level Agreement in Multi-Subscriber IT Infrastructure

(71) Applicant: Sodero Networks, Inc., Cranbury, NJ (US)

(72) Inventors: Yueping ZHANG, Princeton, NJ (US); Lei XU, Princeton Junction, NJ (US)

(21) Appl. No.: 14/589,460

(22) Filed: Jan. 5, 2015

Related U.S. Application Data
(60) Provisional application No. 61/930,694, filed on Jan. 23, 2014.

(51) Int. Cl. H04L 12/24

(52) U.S. Cl. CPC H04L 41/5009; H04L 41/0695

(57) ABSTRACT

A predictive service level agreement (SLA) anomaly detection mechanism is provided for multi-subscriber IT infrastructure. Also, a method of filtering and prioritizing SLA anomaly alerts is provided. Furthermore, a method of constructing a skeleton network given historical and real-time monitoring data and a method of constructing a shadow baseline for each metric in a skeleton network are provided.

### CROSS-REFERENCE TO RELATED APPLICATIONS

This application claims priority to U.S. Provisional Patent Application No. 61/930,694 filed Jan. 23, 2014, which is incorporated herein by reference.

### BACKGROUND OF THE INVENTION

The present invention is in general related to the methods for managing application performance, in particular subscribers' service level agreements (SLAs), in multi-subscriber networks.

Via consolidation and sharing of resources including networks, servers, storage, software and content, Cloud Computing essentially makes computing a commodity and significantly helps businesses reduce capital expenses (CAPEX) and operational expenses (OPEX), simplify management, and improve agility and elasticity. Cloud Computing is changing the way people work and live, as well as the operation and management of today's enterprises. The IT infrastructure—the building blocks of Cloud Computing—is facing unprecedented challenges in system performance and SLA management. Today's data centers have evolved far beyond simple collections of computing and networking equipment and have become ultra-large-scale collaborative computing systems with distributed data processing, computing and network virtualization, and complex business logic. In addition, resource virtualization and multi-tenancy makes it even more challenging for performance guarantee and SLA management for the IT infrastructure for Cloud Computing.

One of the key tools for any SLA management system is the anomaly detection mechanism. However, most existing SLA management systems react to SLA violations after the defects occur and/or do not differentiate the detected SLA violations according to their significance, both of which lead to costly SLA violations and slow defect management responses. Thus, it is desired by the system operators and service providers to develop an SLA management mechanism that can detect potential SLA violations before the events take place and that can filter and prioritize the SLA anomaly alerts according to their importance.

### SUMMARY OF THE INVENTION

The preferred embodiment describes a predictive SLA anomaly detection mechanism for multi-subscriber IT infrastructure. The mechanism is composed of a Data Fusion module, an SLA-aware Skeleton Modeling module, a Shadow Baselining module, a System Analysis and Alerts Generation module, and an SLA-aware Alerts Prioritization module. In one embodiment, the Skeleton Modeling module takes as input the preprocessed system monitoring data and generates a skeleton network describing the system characteristics. In another embodiment, the Shadow Baselining module takes as input the preprocessed monitoring data and the skeleton network and generates a list of shadow baselines for each metric. In another embodiment, the Alerts Prioritization module takes as input the alerts accumulated over a certain time interval and generates as the output a ranked list of alerts according to their significance of the potential SLA violations.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 illustrates the general scenario of a multi-subscriber utility infrastructure;

FIG. 2 illustrates the components and steps of an SLA anomaly detection system for multi-subscriber utility facilities;

FIG. 3 illustrates the input and output of the Data Fusion module;

FIG. 4 describes the procedure of constructing a skeleton network;

FIG. 5 illustrates an exemplary skeleton network;

FIG. 6 describes the procedure of constructing the shadow baseline of a skeleton network;

FIG. 7 describes the procedure of conducting an SLA-aware Prioritization for alerts triggered according to a given skeleton network and its shadow baseline.

### DETAILED DESCRIPTION OF THE PREFERRED EMBODIMENTS

Certain terminology is used in the following description for convenience only and is not limiting. The words “right,” “left,” “lower,” and “upper” designate directions in the drawings to which reference is made. The terminology includes the above-listed words, derivatives thereof, and words of similar import. Additionally, the words “a” and “an,” as used in the claims and in the corresponding portions of the specification, mean “at least one.”

In general, preferred embodiments of the present invention relate to the methods for managing application performance, in particular subscribers' service level agreements (SLAs), in multi-subscriber networks.

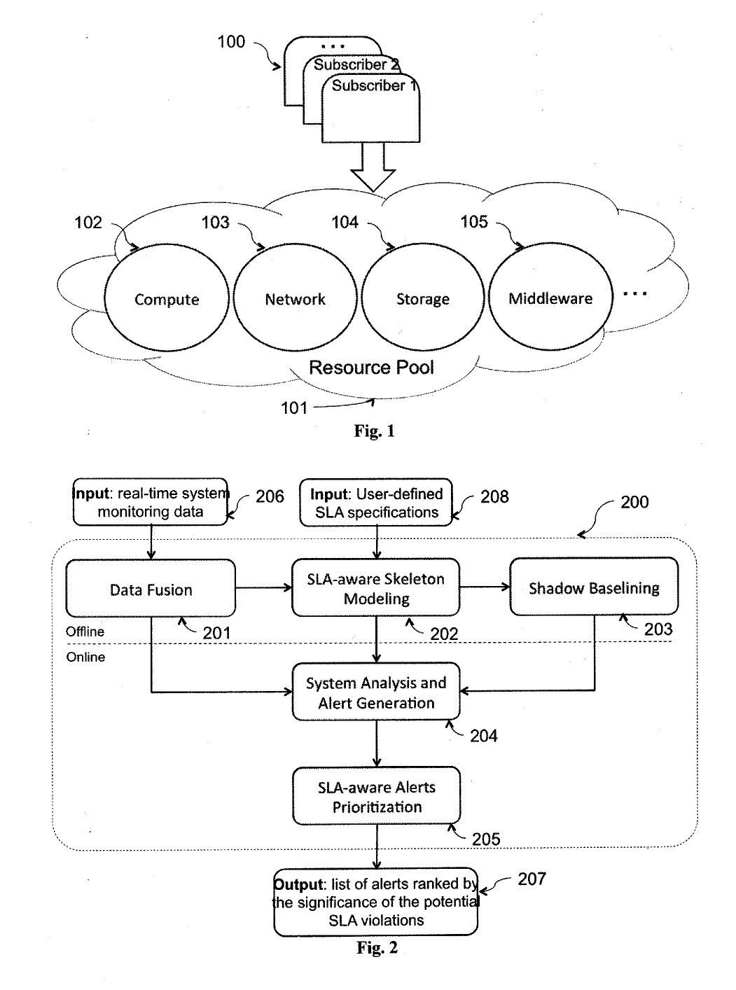

FIG. 1 is an exemplary generic structure of a multi-subscriber utility facility, which is composed of a plurality of subscribers 100 and a shared resource pool 101. Resources in the resource pool 101 can be located in a single facility or be geographically distributed. Resources in a resource pool include, but are not limited to, compute 102 (i.e., physical or virtual computer servers), network 103 (network switches, routers and the interconnects), storage 104 (i.e., local, remote, or Cloud storage), and middleware 105 (i.e., firewall, load balancer, intrusion detection systems, and other appliances). A plurality of subscribers 100 deploys their own applications on the shared resource pool 101, utilizing a combination of a certain amount of compute 102, network 103, storage 104, middleware 105 and other resources.

For each subscriber, the operator or service provider of the shared resource pool 101 specifies a pre-determined service level agreement (SLA), defining a set of performance guarantees for the subscriber's services as a whole or for each individual application component deployed in the shared resource pool 101. An exemplary set of SLAs includes system uptime, network bandwidth, latency, storage access rate, recovery time, etc. These SLAs can be quantitatively defined as a set of static threshold values or time-varying baseline functions. In practice, the operator or service provider monitors the service performance according to the SLAs, triggers alerts if certain SLAs are violated, and takes actions to resolve or mitigate the violated SLAs. Since these actions are reactive, i.e., triggered after the violations take place, they cannot prevent, but only mitigate, the losses cost by the SLA violations. In this invention, a method that is able to proactively detect and react to potential SLA anomaly before the actual violations occur.

In the preferred embodiment, referring to FIG. 2, a proactive SLA anomaly detection system 200 is composed of a Data Fusion module 201 that performs sanitization, extraction and transformation of raw monitoring data such that the resulting data are easier for further analysis, an SLA-aware Skeleton Modeling module 202 that constructs a set of time-invariant mathematical constraints of a given system while embedding the service level agreement information in the mathematical model, and Shadow Baselining module 203 that constructs a set of expected baseline functions for each metric according to the mathematical relationships between any pair of metrics modeled by the skeleton modeling, a System Analysis and Alerts Generation module 204 that analyzes the system situation and accordingly generates alerts following predefined fault criteria, and an SLA-aware Alerts Prioritization module 205 that filters and prioritizes SLA alerts based on the significance of the alerts. The SLA anomaly detection system 200 takes as input real-time system monitoring data 206 and generates as output a ranked list of alerts 207 according to the significance of the potential SLA violations.

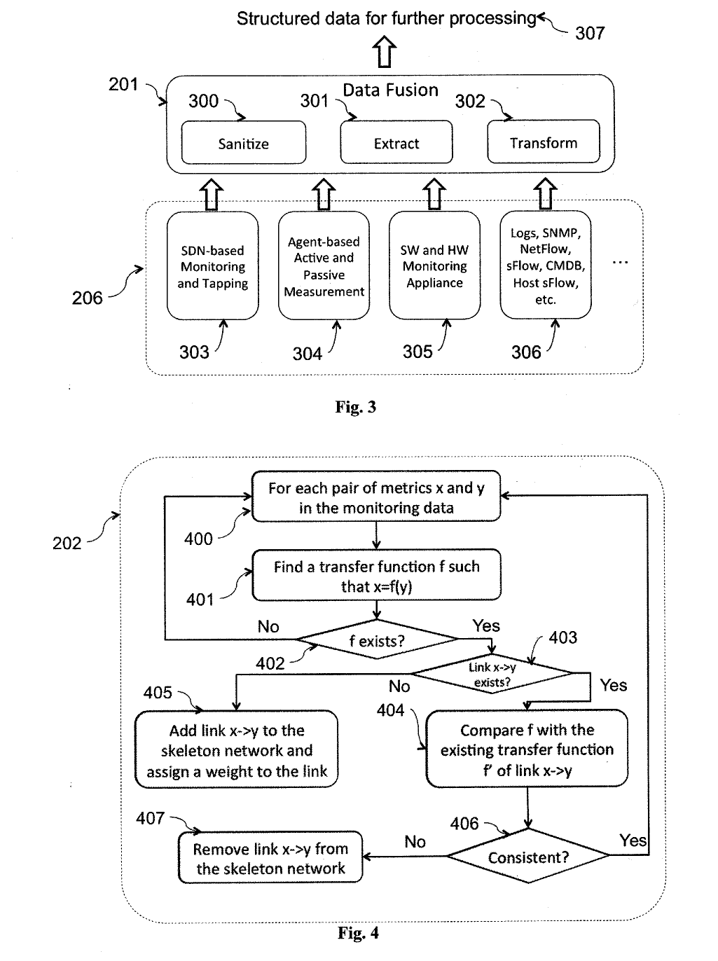

In one embodiment, referring to FIG. 3, the input, real-time system monitoring data 206, of the Data Fusion module 201 can be any combination of SDN-based monitoring and tapping data 303, agent-based passive and active measurement data 304, software and hardware appliance data 305, and any other monitoring data 306, including SNMP, sFlow, NetFlow, IP-FIX, jFlow, syslog, and CMDB. Given the real-time monitoring data 206, the Data Fusion module 201 generates the structured data 307 for further processing after sanitization 300, extraction 301, and transformation 302. Other approaches, techniques and designs to achieve the above data preprocessing functionality are known to those skilled in the art, and are within the scope of this disclosure.

In another embodiment, the Skeleton Modeling module 202 takes as input the preprocessed system monitoring data 307 and generates a skeleton network describing the system characteristics using a set of time-invariant mathematical constraints of a given system while embedding the service level agreement information in the mathematical model. Referring to FIG. 4, the procedure of constructing a skeleton network is described as follows. The procedure starts at step 400, where each pair of metrics x and y in the input data is iterated. In each iteration, the procedure, at step 401, finds a transfer function f satisfying x=f(y). An exemplary method of finding such a transfer function is the Auto-Regressive method with Exogenous inputs. But other approaches and techniques to achieve the above functionality are known to those skilled in the art, and are within the scope of this disclosure. At step 402, the system examine transfer function f with the existing transfer function that was constructed for metrics x and y and checks whether transfer function f exists. If function f does not exist, the procedure skips to the next iteration; otherwise, the procedure checks whether link x->y exists in the skeleton network at step 403. If the link does not exist in the skeleton network, at step 405, add link x->y to the skeleton network and assign a weight to the link according to its significance to the SLAs of the affected subscribers. If the link x->y already exists in the skeleton network, at step 404, compare f with the transfer function of the existing link x->y in the network. According to the examination result, the links of the skeleton network is updated as follows. If the two transfer functions are consistent, keep the link x->y in the skeleton network and go to the next iteration; otherwise, at step 407, remove the link x->y from the skeleton network and go to the next iteration. The procedure iterates until no new input data are received.

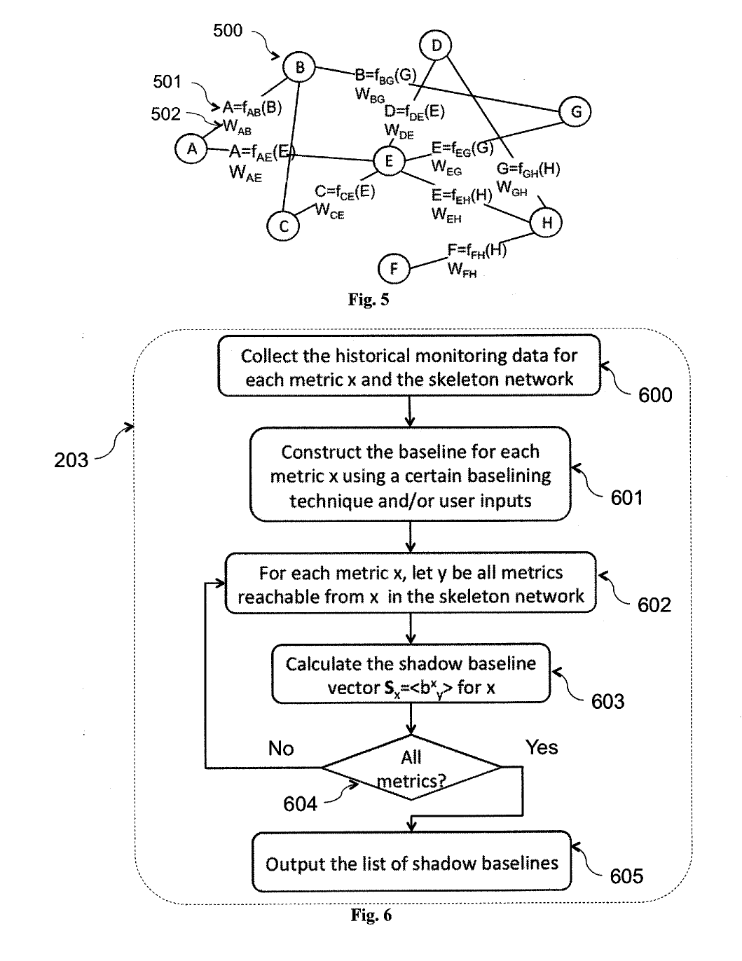

An exemplary skeleton network is illustrated in FIG. 5. Each node in the skeleton network represents a metric 500. Each link connecting two nodes A and B is associated with a transfer function f_{AB} 501 and a weight W_{AB} 502. A skeleton network is not static, but is continuously and dynamically validated and adjusted according to the procedure 400.

In another embodiment, the Shadow Baselining module 203 takes as input the preprocessed monitoring data 307 and the skeleton network and generates a list of shadow baselines for each metric using monitoring data, which represent a set of expected baseline functions for each metric according to the mathematical relationships between any pair of metrics modeled by the skeleton modeling. FIG. 6 illustrates the procedure of constructing the shadow baselines. The procedure starts at step 600, where the system takes the input data. At step 601, the system constructs a baseline function bₓ^{x} for each metric x (or node 500) in the skeleton network using any baselining or profiling technique. The system at step 602 identifies all nodes y reachable from x in the skeleton network and at step 603 calculates the baseline function by^{x} propagated from node x following the transfer function associated with the link in the skeleton network. Then, the vector of shadow baseline Sₓ of metric x is defined as Sₓ=<by^{x}>. If all metrics have been iterated at step 604, the system outputs the list of shadow baselines for metric x; otherwise, the system goes back to step 602 and iterates the next metric.

Shadow baselines of a metric x represent the expected baselines of all metrics y that are reachable from x in the skeleton network. These expected baselines are further used to verify a triggered alert is a true positive or false positive. This information is further used to filter and rank the importance of the alerts triggered by the System Analysis and Alerts Generation module 204.

In another embodiment, the System Analysis and Alerts Generation module 204 takes as input the preprocessed monitoring data 307 and the baseline for each metric and compares the monitored value of each metric with its baseline function to analyze the system situation and accordingly generate alerts following predefined fault criteria. Specifically, if the baseline function is violated according to a predefined fault model, then the system reports an alert and feeds the alert to the Alerts Prioritization module 205. Approaches, techniques and designs to detect the above baseline violations are known to those skilled in the art, and are within the scope of this disclosure.

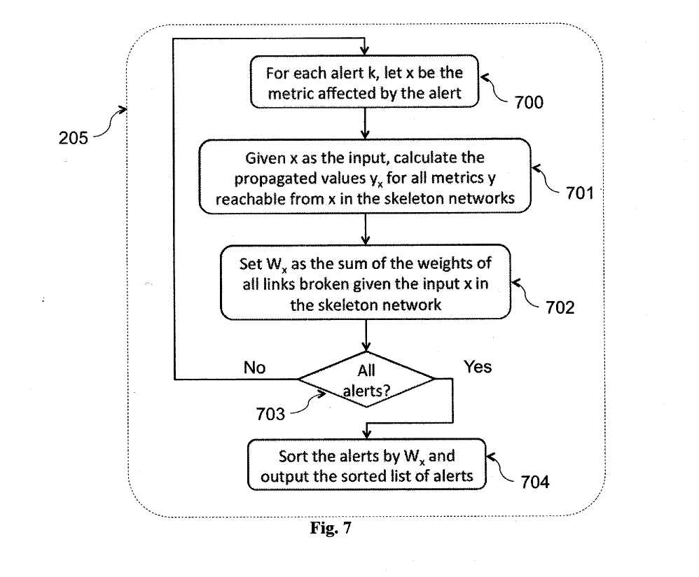

In another embodiment, the Alerts Prioritization module 205 takes as the input the alerts accumulated over a certain time interval and generates as the output a filtered and prioritized list of alerts according to their significance of the potential SLA violations. Referring to FIG. 7, the procedure of ranking the triggered alerts starts at step 700, in which, for each alert x, the metric x affected by this alert is identified. At step 701, for all metrics y that are reachable from x in the skeleton network, calculate the projected value of y propagated from metric x by following the transfer function of each link in the path from metric x to metric y. At step 702, for each link in the reachable paths from x, examine whether the link is broken according to both of its regular and shadow baselines. Then, let Wₓ be the sum of the weights of all broken links in the reachable paths from x. At step 704, sort the alerts according to their weights Wₓ and output the sorted list.

In the above procedure, it is possible that the weight of an alert is zero or has a very low value, which implies that this alert is a false positive and should be removed from the alert list. Other approaches, techniques and designs to achieve the above fault suppression functionality are known to those skilled in the art, and are within the scope of this disclosure. This way, the operator or service provider can focus on the more important alerts and process these alerts according to their significance.

The procedures described in FIGS. 3-4 and 6-7 constitute a proactive SLA anomaly detection mechanism for multi-subscriber IT infrastructures. Instead of reactively respond to SLA violations, which already caused costly damages to the quality of service and user experience, the present invention is able to predict potential SLA violations leveraging robust deep system modeling such as skeleton networks and shadow baselining. The proposed method of prioritizing SLA anomaly alerts is able to filter out false or irrelevant alerts and allows the service providers to efficiently pinpoint and treat the more significant alerts, significantly improving the defect management responsiveness and resolution efficiency.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A predictive SLA anomaly detection mechanism for multi-subscriber IT infrastructure; the predictive SLA anomaly detection mechanism comprising:
a Data Fusion module that performs sanitization, extraction and transformation of raw monitoring data such that the resulting data are easier for further analysis, the Data Fusion module having an output;
an SLA-aware Skeleton Modeling module having an input that receives the output of the Data Fusion module, wherein the SLA-aware Skeleton Modeling module constructs a set of time-invariant mathematical constraints of a given system while embedding the service level agreement information in the mathematical model, the SLA-aware Skeleton Modeling module having an output;
a Shadow Baselining module having an input that receives the output of the SLA-aware Skeleton Modeling module, wherein the Shadow Baselining Module constructs a set of expected baseline functions for each metric according to the mathematical relationships between any pair of metrics modeled by the skeleton modeling, the Shadow Baselining module having an output;
a System Analysis and Alerts Generation module having an input that receives the output of the Data Fusion module, SLA-aware Skeleton Modeling module, and the Shadow Baselining module, wherein the System Analysis and Alerts Generation module analyzes the system situation and accordingly generates alerts following predefined fault criteria, the System Analysis and Alerts Generation module having an output; and
an SLA-aware Alerts Prioritization module having an input that receives the output of the System Analysis and Alerts Generation module, wherein the SLA-aware Alerts Prioritization module filters and prioritizes SLA alerts based on the significance of the alerts.

2. A method of constructing the skeleton network given historical and real-time monitoring data, the method comprising:
finding a transfer function for each pair of metrics;
examining whether the transfer functions found in the previous step already exist; and
updating the links of a skeleton network according to the examination results obtained in the previous step.

3. A method of constructing a shadow baseline for each metric in a skeleton network, the method comprising:
constructing a baseline for each metric using monitoring data; and
constructing a list of shadow baselines for each metric using a skeleton network.

4. A method of filtering and prioritizing SLA anomaly alerts, the method comprising:
calculating, for each alert, the expected baseline for all metrics reachable from a metric affected by the given alert;
calculating the weighted sum of each alert; and
sorting the alerts according to the weights of the alerts.
